(19) United States
(12) Patent Application Publication
(10) Pub. No.: US 2006/0138104 A1
(43) Pub. Date: Jun. 29, 2006

(54) Fuel cell and liquid container sealant removal system

(76) Inventor: Paul Warren DeVore, Dublin, OH (US)

Correspondence Address: Paul Warren DeVore, 6000 Riverside Drive A332, Dublin, OH, 43017, US

(21) Appl. No.: 11/260,797

(22) Filed: Oct. 28, 2005

Related U.S. Application Data
(63) Continuation-in-part of application No. 10/126,138, filed on Apr. 19, 2002.
(60) Provisional application No. 60/293,315, filed on May 25, 2001.

(51) Int. Cl. B23K 26/38; B23K 26/14; B23K 26/03

(52) U.S. Cl. 219/121.69; 219/121.84; 219/121.83; 264/400

(57) ABSTRACT

An integrated system for removing coatings and sealants from substrates used to form internal fuel cells of aerospace vehicles using a high-power pulsed CO₂ laser capable of providing the energy required to completely remove all sealant by explosively detaching and vaporizing the sealant via a specially designed flexible, multi-segmented articulated wand.

This application claims the benefit of U.S. Patent Office Provisional Patent Application No. 60/293,315 filed on May 25, 2001, confirmation number 1644.

### FIELD OF THE INVENTION

The present invention relates to a system for the removal of sealants from fuel cells and containers used for liquid storage.

### BACKGROUND OF THE INVENTION

The maintenance and repair of fuel cells for aircraft and other liquid storage tanks is a time consuming, onerous and costly maintenance problem. Wet wing or integral fuel cells are created within the structure of aircraft wings and fuselage sections by compartmentalizing the structure and using a special sealants to retain the fuel within the various compartments. The sealant eventually deteriorates or is damaged and must be removed and new sealant applied.

The nature of the tank structure, the characteristics of the sealant to be removed and safety issues contribute to making the sealant removal process a time consuming and costly task. In addition, current methods do not always assure that all sealant is removed.

Current methods of removal include mechanical scraping, chemical solvents and the use of high velocity water jets. These methods are labor intensive and costly. Each method has distinct disadvantages. Worker health problems of various types are associated with each of the current removal processes.

With respect to the high velocity water jet systems, workers must be protected using special clothing and eye protection, procedures followed to assure control of potential damage to the delicate substrates of tank structures and a means of disposing of high volumes of water contaminated with the sealant must be provided.

The chemical process involves the use of toxic “paint removal type” chemicals that can affect the skin and respiratory functions of workers. Special disposal methods are required for the chemicals used and the sealant material removed.

The mechanical scraping process involves the use of scrapers that can damage the delicate substrates of fuel cells and other similar containers. In the case of plastic scrapers, they break often during use and injure the worker. In addition, workers must operate in physically compromising positions. The arms and hands of the worker are subject to injury from sheet metal edges of the tank structure. The work is physically demanding and stressful.

The sealant is applied over all rivets and angular structural shapes that comprise the compartments of the fuel cells. The removal of sealant material from fuel cells and similar containers used to store various forms of liquid becomes more of a problem when the spaces holding the liquid are small and the access and entries to the interior of the cells and containers are limited in number and size.

Within the wet wing or integral fuel cells and other similar liquid containers, there are crevices and corners where the removal of deteriorated sealant is very difficult. Complete removal of all sealant is not always achieved. In the smaller tank sections, it is very difficult to reach the sealant and to visually observe the work area.

Workers must use hand-held mirrors to view the work areas. It is difficult to position the mirror, retain the mirror in the correct position and provide sufficient light in the confined spaces, while at the same time engage in a physically demanding sealant removal process.

Commercial and general aviation aircraft fleets are aging. As aircraft age, fuel cell sealant deteriorates. Some aircraft repair stations attempt to reseal the tanks in the specific area of the leaks. This is done to reduce the high cost and long down time associated with the task of removing all sealant and resealing all tank areas.

Those experienced with the problem of repairing leaking fuel cells and other similar containers have discovered that patching is only a temporary solution. The sealant in other areas of the fuel containers continues to deteriorate and leaks appear in other sections of the liquid storage containers. This necessitates taking the aircraft or other vehicles and units out of service, reopening the container, removing old sealant in the suspected leak areas, resealing, and returning the aircraft to service. In addition to the cost associated with reopening and resealing the fuel cells, the aircraft must be ferried to a certified repair station and be out of service for extended periods of time. Other liquid storage containers have the same costs and shipping requirements and qualified repair facility requirements.

The only solution that eliminates or greatly reduces the piecemeal continuous resealing process is to completely remove all of the old sealant and to reseal the fuel cells or liquid storage container. This route is costly in terms of labor and time using current methods. The manufacturer of one type of aircraft estimates that 60 person hours is required to remove and reseal two 32-gallon fuel cells. Later models of the same aircraft require 70 hours of labor. This estimate is based on the standard factory recommended hand mechanical scraping process for sealant removal. Other models of aircraft will vary in costs and time by size and number of fuel cells.

When a complete resealing operation is done, the aircraft may be out of service from two to five weeks. A complete resealing job on the aircraft referenced can cost from $5200 to $9,000. The cost varies and depends on the facility doing the work. Any additional work required on the wing structure, such as replacing loose rivets, fuel gage and sender repair, fuel filler ring replacement and fuel sample drain valve replacements, add to the cost. Costs on other similar containers vary with complexity, size, type of construction, and attachments such as gages, valves and other components.

Many repair stations do not accept tank sealant removal and resealing work because of the difficult and onerous nature of the sealant removal process. Numerous makes and models of aircraft, ranging from single engine aircraft, to light twin engine aircraft, to medium sized business and corporate jets, to large commercial passenger, cargo aircraft and military aircraft, use wet wing or integral fuel tank systems.

The removal approach using mechanical scraping presents a problem of trace residues of the sealant particulate remaining in the tank sections. This presents a safety problem when all of the old sealant is not removed and some remains in the fuel cells in hard to reach places. There is the possibility particles of the old sealant will cause a fuel flow blockage if the tanks are not cleaned and purged carefully.

The chemical removal process also has the problem of chemical residue. This residue may remain in crevices around rivets and in joints where sheet metal overlaps within the fuel cells or containers. If not removed completely, the residue has the potential for deteriorating the new sealant over time.

It would, therefore, be desirable to provide a system that is efficient, does not damage the intricate nature of the substrate of the structure of the fuel cells or liquid storage container, leaves no residues, as do chemical, mechanical and water-pic operations, and improves the health, safety and physical environment of the workers.

Accordingly, a need exists in the art for apparatus that uses a specially designed integrated, monitored and externally controlled high- power CO₂ pulsed laser or similar light source.

### SUMMARY OF THE INVENTION

It is an object of the invention to provide a system for removing sealants from liquid storage containers having a flexible articulated wand with a delivery head formed with lighting and imaging means for illuminating sealant materials within a storage container and enabling an operator to selectively direct a high-power pulsed CO₂ laser beam to explosively detach and vaporize illuminated sealant materials and continuously image collection and removal of the sealant materials in an ambient oxygen atmosphere and continuously collecting and removing the vaporized sealant materials from the storage containers.

In a preferred embodiment of the invention, a portable liquid storage container sealant removal system has a CO₂ laser for generating a high powered light beam of uniform density with a variable pulse rate of ten to one thousand hertz per second. The portable liquid storage container sealant removal system has an articulated wand with an angular adjustable lens structure with a delivery head for focusing, directing and delivering the high-power pulsed CO₂ laser light beam to operator selected internal surfaces of the storage containers. A focusing lens terminates the angular adjustable lens structure for delivering the high-power pulsed CO₂ laser light beam to operator selected internal surfaces of the storage container. High volume gas and particulate filtering apparatus is attached to an evacuation hose sized for insertion in combination with the articulated wand into an access port of the storage container to evacuate the vaporized sealant materials from the storage container. Monitoring apparatus coupled through the articulated wand to the delivery head continuously images the collection and removal of the sealant materials and enables the operator to guide the delivery head to sealant materials within the storage container and monitor and record each operation of removing the sealant materials.

### BRIEF DESCRIPTION OF THE DRAWING

For a further understanding of the objects and advantages of the present invention, reference should be had to the following detailed description, taken in conjunction with the accompanying drawing figures, in which like parts are given like reference numerals and wherein FIG. 2 is an overall view of a system for removing sealants from inside liquid storage containers in accordance with the principles of the invention, FIG. 3 illustrates delivery head apparatus set forth in FIG. 2 for illuminating sealant materials within a liquid storage container, delivering a high-power pulsed CO₂ laser beam to the illuminated sealant materials to explosively vaporize and continuously image the sealant materials, and

FIG. 4 illustrates the articulated wand adjustable lens structure set forth in FIG. 2 for delivering a high-power pulsed CO₂ laser light beam to operator selected internal surfaces of the storage containers.

### DETAILED DESCRIPTION OF THE INVENTION

FIG. 2 of the drawing illustrates a typical wing section of an aircraft having limited access to the liquid storage container areas requiring sealant removal in a typical aircraft fuel cell through access panels. All tools used to remove sealants, the work-site lighting, mirrors and other visual devices and the hands and arms of the worker, enter the tank to do the sealant removal process through these access panels.

FIG. 2 also illustrates the complete high-power pulsed CO ₂ laser sealant removal system 10 of the instant invention in place and set up to remove sealant from the interior fuel cells of a typical general aviation aircraft. Sealant removal system 10 has the advantage that a single operator can position the aircraft and set up the complete system. With the aircraft in place, fuel is drained from the fuel tanks and the tanks purged with steam and ventilated for a 24 hour period prior to proceeding with any work. Whether operating on-site or off-site, the set-up for the sealant removal operation is the same except for the electrical power hook up for the system. The aircraft is repositioned to a selected work place and the cantilevered portable sealant removal system 10 equipment is moved into position as shown in FIG. 2.

With the aircraft in place, the operator places location marks on each access panel and adjacent wing sections to assure proper alignment on replacement. Each access panel is assigned a number to assure that the panel is replaced in the same access entrance in the wing. Retaining screws, holding the panels in place are then removed, and using a procedure established to assure that no damage is done to the wing structure or access panel, the access panels are detached from the wing plate.

Sealant removal system 10 comprises a high-power pulsed CO₂ Laser source 101 coupled to an articulated wand 104 terminated in delivery head 103. Gas and particulate evacuation hose 102 provided for insertion into an access panel opening extends from a high-volume vacuum gas and particulate evacuation and filtering system 106. Work site monitor 107 is used to monitor the sealant removal operation. Work site monitoring and recording system 108 coupled with articulated wand 104 and with control, monitoring and recording system 109 monitors and records the sealant removal operation occurring within the aircraft fuel cell.

Cantilevered portable system equipment stand 100 mounts the components of sealant removal system 10 and allows the system to be easily moved to service aircraft. Laser power supply 111 is controlled by foot control switch 113. Activation of power manager and switching system ancillary equipment 112 provides and directs power for work site imaging device 1032, external monitor 107, work site monitoring and recording system 108, computerized system control monitoring and recording system 109, and high intensity work light source 110. Foot control switch 113 controls power for power supply 111 for high power pulsed laser 101. Auxiliary power supply 114 provides auxiliary power for off-site operation of the system 10. Work site imaging device 1032 coupled with articulated wand 104 enables imaging of the fuel cell sealant removal operation..

For on-site operations, a power cable is connected from the on-site power panel and to the power distribution panel and to the power manager and switching system ancillary equipment 112. A power cable is connected from the power switching system to power supply 111 serving the high power pulsed CO₂ Laser source 101. Following the connection of the power cables to the power supplies the current is turned on and power supply 111 and power manager and switching system ancillary equipment 112 activated.

For off-site operations a power cable is connected from an off-site triple fuel electric generator auxiliary power supply to the power distribution panel and a power cable connected from the distribution panel to power supply 111 serving the high power pulsed CO₂ laser 101. A power is connected from the power distribution panel to the power manager and switching system for ancillary equipment 112. The electric generator is activated and power output observed and adjusted. Power is directed to power supply 111 and power manager and switching system ancillary equipment 112.

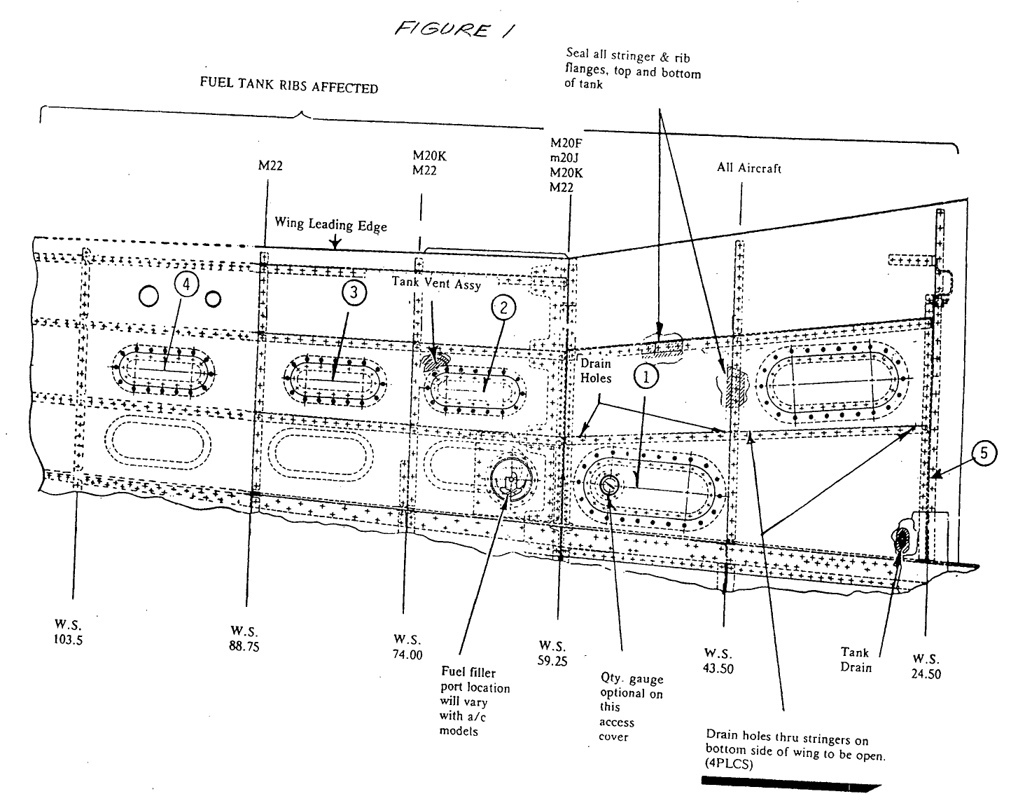

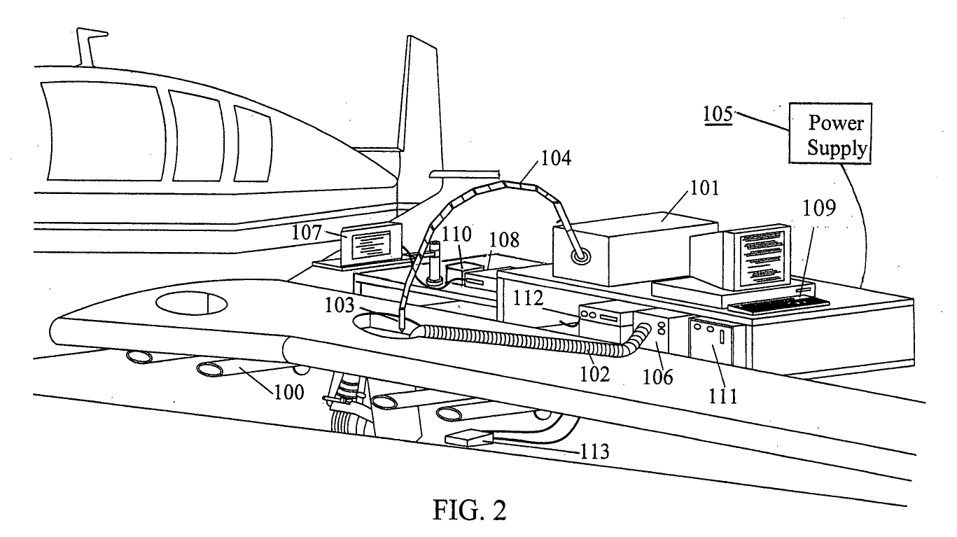

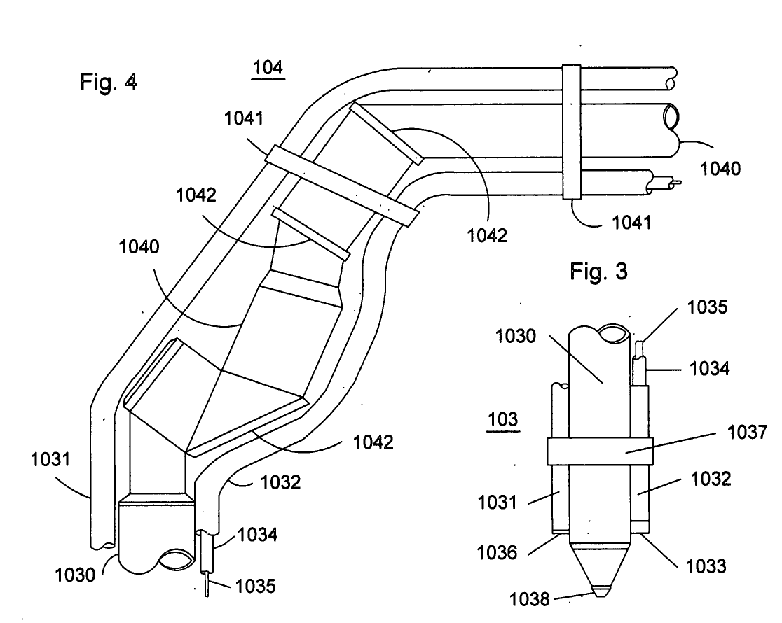

The flexible, fully directional, multi-segmented articulated wand 104, FIG. 4, is terminated at one end with laser beam delivery head 103, FIG. 3, sized for insertion into an access port of a fuel cell storage container and has the other end connected to the high power pulsed CO₂ laser 101. Full directional flexibility of articulated wand 104 is essential. Articulated wand 104, FIG. 4, is formed with multiple short connected segments 1040 that enable articulated wand 104 terminated with delivery head 103 to be maneuvered easily to access the intricate interior spaces of the fuel cells and liquid storage containers. Articulated wand 104 formed with the short connected segments 1040 contains directing and focusing angular adjustable lens structures 1042 that enable the operator to selectively and continuously direct a high-power pulsed CO₂ laser light beam of uniform density with a variable pulse rate of ten to one thousand hertz per second to explosively detach and vaporize immediately the sealant materials in an ambient oxygen atmosphere within the storage container, The articulated wand 104 and delivery head section 1030 are maneuvered within the confines of the internal structure of the storage containers. The operator selects the area in the fuel cell storage container where work will begin and positions articulated wand 104 and delivery head 103 in the selected location in the storage container through an access panel and tests articulated wand 104 with the delivery head 103 for range of movement, making any adjustments that are necessary. Delivery head section 1030 of articulated wand 104 has a directing and focusing lens 1038 terminating the angular adjustable lens structure 1042 of articulated wand 104 for delivering the high-power pulsed CO₂ laser light beam to the operator selected internal surfaces of the storage container.

Delivery head 103, Fig, 3, is formed with an integral work-site light source 1036 and work site color camera 1032 having a lens 1033 affixed thereto and held in place by bond 1037. Color imaging camera device 1032 is connected by cable 1034 and conductor 1035 extending through articulate wand 104 to work site monitoring and recording system 108. Work site high intensity lighting source 110 is connected to fiber optical cable 1031 that delivers light to the work site through the optical fiber cable 1031 affixed by bond 1037 to delivery head structure 1030. Terminating lens 1036 is used to illuminate dense, thick, rubber-like, and toxic sealant materials within a storage container that are to be removed. Color imaging camera device 1032 and lens 1033 are also held in place on delivery head 103 by bond 1037 and connected by cable 1034 and conductor 1035 through articulated wand 104 to work site monitoring system 108. This apparatus continuously images the collection and removal of the sealant materials and enables the operator to guide delivery head 103 to sealant materials within the storage container and monitor and record each operation of removing sealant materials.

When the laser power supply 111 and work site imaging camera device 1032 are activated, the operator using imaging camera 1032 and monitor 107, can position the delivery head 103 to begin the process of sealant removal in the selected work area of the fuel cell. In operation, the activation of the laser explosively detaches and immediately vaporizes the sealant in an ambient oxygen atmosphere resulting in a gas and particulate residue that is evacuated through the gas and particulate evacuation hose 102 to the gas and particulate vacuum filtering system 106. There is no charring or burning of the sealant and no residue remains in the fuel cell or on the surface of the fuel cell substrate. The result of this process is that the surface of the fuel cell substrate is of a quality that allows the immediate application of new sealants without further cleaning, mechanical or chemical acts. In addition, the metallurgical quality of the aluminum substrate of the fuel cell is improved by the action of the high-power pulsed CO₂ laser 101. The operator continues the sealant removal process by monitoring removal of the sealant on monitor 107. The production rate capability of the high power pulsed CO₂ laser 101 in explosively detaching and immediately vaporizing the sealant is a minimum of 2-3 square feet per hour for sealant with an average thickness of ⅛″.

After removing the sealant, articulated wand 104 and delivery head 103 together with the gas and particulate evacuation hose 102 are removed from the fuel cell. The fuel cell is inspected by the operator and approved for the resealing process to begin. The fuel cell is resealed, inspected, the access panels replaced. The sealant is cured and fuel is placed into the cell and the aircraft returned to service. The high-power pulsed CO₂ laser 101 is activated by floor switch control 103 and is comprised of a high power pulsed CO₂ laser with a minimum of 1 K-watt average output power with a pulse width of 15-20 microseconds that runs multi-mode. The high-power pulsed laser is capable of delivering to the work site through a specially designed flexible, multi-segmented, articulated wand 104, a beam of uniform density with a variable pulse rate of from 10 to 1 K Hz per second and a variable depth of focus at the work site. The high-power pulsed CO₂ laser 101 is capable explosively detaching and vaporizing immediately the sealant in an ambient oxygen environment and providing a minimum material removal rate of 2-3 square feet per hour for sealant with an average thickness of ⅛″.

The directing and focusing lens 1038 of delivery head structure 103, FIG. 3, adjusts the high-power pulsed CO₂ laser light beam to the proper size and divergence for delivery of the beam through the flexible, multi-segmented, articulated wand 104. The lens system 1042 of articulated 104, FIG. 4, is capable of angular adjustments that enables delivery of the CO₂ laser light beam at maximum power to all surfaces of the intricate, complex, irregular interior structures of liquid containers such as wet wing fuel cells of aircraft. The laser light beam delivery head structure 103, FIG. 3, located at the end of adjustable articulated wand 104 is attached to high-power pulsed CO₂ laser 101 and receives the light beam generated by the CO₂ laser and directs the beam to the location of the sealant.

Delivery head 103 is formed with a high intensity light source 1036 connected to fiber optic cable 1031 and work-site light source 1036 and a high-resolution imaging device 1032. Auxiliary light source 1036 provides a high quality light source for the imaging device 1032 and enables the transmission of a high quality image of the work in progress to an external work site monitor 107 via imaging cable 1034, FIG. 3. Work site monitor 107 is a color monitor that displays the fuel cell work site to the operator and enables the operator to view all fuel cell work in process. Delivery head structure 1030 with lens 1038 is designed to provide a minimum 0.6 square centimeter beam footprint with a uniform density across the beam.

Gas and particulate evacuation hose 102, FIG. 2, is used to evacuate vaporized gases and particulate from the work site to the high volume vacuum gas and particulate filtering system 106 and is monitored on a continuous basis.

High-volume vacuum gas and particulate filtering system 106 provides for the evacuation of all vaporized gases and particulates produced during the removal process. The vacuum filtering system 106 is linked to the work site through flexible evacuation tubing 102. The vaporized material travels through tubing 102 to the gas and particulate filtering system 106. The filters are monitored constantly during the removal process and replaced as determined by a preset standard. The filters are disposed of according to Environmental Protection Agency Standards.

Worksite monitoring and recording system 108 consists of an imaging camera device 1032, transmission cable 1034, monitor 107, and recording unit 108. The unit is activated and transmits color images to the external monitor 107 for use by the operator in guiding the delivery head 103 of articulated wand 104 during the sealant removal operation. Worksite monitoring and recording system 108 records, stores and provides information for review to provide quality assurance for each job and to retain a record for future reference.

System control, monitoring and recording system 109 provides the means to externally configure, calibrate and maintain the predetermined operational parameters of the high-power pulsed CO₂ laser 101. This unit records total time of operation, unit times of operation (starts and stops), unit power settings, temperatures, and other information necessary for the precision operation of the system and the retention of information for review and revision of system operation.

Cantilevered portable equipment stand 100 is used to mount the sealant removal system apparatus. The apparatus that powers sealant removal system 10 is comprised of an on-site power panel, triple fueled electric generator for off-site operations, connecting power cable, a power switching system, laser power supply, a power manager and switching system for ancillary equipment, laser power supply unit and foot control control switch. High-resolution imaging device 115 displays, monitors and records the work in progress.

It is obvious from the foregoing that the facility, economy and efficiently of removing sealant from fuel cells and containers is improved by a portable CO₂ laser system designed to remove undesirable sealant from fuel cells and containers by exploding the sealant in an ambient oxygen atmosphere and removing the particulates and debris from the fuel cell. While the foregoing detailed description has described an embodiment of the inventive apparatus in accordance with principles of the invention, it is to be understood that the above description is illustrative only and is not limiting of the disclosed invention. Particularly other configurations of a high-power pulsed CO₂ sealant removal apparatus ma be used as the inventive apparatus. Thus, the invention is to be limited only by the claims set forth below.

What is claimed is:

1. (canceled)

2. A system for removing sealants from liquid storage containers comprising
a portable CO₂ laser sealant removal system that explosively detaches and vaporizes sealant materials in an ambient oxygen atmosphere from within a storage container,
adjustable lens means having a delivery head affixed to the end thereof and sized for entry into an access port of the storage container for delivering a high-power pulsed CO₂ laser light beam to internal surfaces of the storage container,
means for removing and continuously collecting the vaporized sealant materials,
means affixed to the delivery head for continually imaging removal processes and recording an external image of the removal processes,
means affixed to the delivery head for delivering a light beam to the storage container for illuminating imaging and recording sealant removal processes,
means for controlling operation of imaging and recording operation variables and parameters.

3. A system for removing sealants from liquid storage containers comprising
a portable laser sealant removal system having a flexible articulated wand with a delivery head affixed to the end thereof and formed with lighting and imaging means affixed thereto for illuminating sealant materials within a storage container and enabling an operator to selectively direct a high-power pulsed CO₂ laser beam to explosively detach and vaporize illuminated sealant materials and continuously image collection and removal of the sealant materials in an ambient oxygen atmosphere within the storage container, and
means for continuously collecting and removing the vaporized sealant materials from the storage containers.

4. The liquid storage container sealant removal system set forth in claim 3 wherein said portable sealant removal system comprises
a CO₂ laser connected with the articulated wand opposite the delivery head for generating a high powered light beam of uniform density with a variable pulse rate of ten to one thousand hertz per second.

5. The liquid storage container sealant removal system set forth in claim 4 wherein said articulated wand comprises
angular adjustable lens structure for focusing, directing and delivering the high-power pulsed CO₂ laser light beam to operator selected internal surfaces of the storage container.

6. The adjustable lens structure set forth in claim 5 wherein said articulated wand delivery head comprises
a focusing lens terminating the angular adjustable lens structure for delivering the high-power pulsed CO₂ laser light beam to the operator selected internal surfaces of the storage container.

7. The continuously collecting and removing means set forth in claim 6 comprising
high volume gas and particulate filtering apparatus having an evacuation hose sized for insertion in combination with the articulated wand into an access port of the storage container to evacuate the vaporized sealant materials from within the storage container.

8. The imaging means forth in claim 7 comprising
monitoring apparatus coupled through the articulated wand to the delivery head for continuously imaging the collection and removal of the sealant materials and enabling the operator to guide the delivery head to sealant materials within the storage container and monitor and record each operation of removing sealant materials.

9. A system for removing sealants from liquid storage containers comprising
a portable laser sealant removal system having a CO₂ laser coupled to a flexible articulated wand with an angular adjustable lens structure terminated in a delivery head affixed to the end of the articulated wand and sized for insertion into an access port of a fuel cell storage container and formed with lighting and imaging means affixed thereto for illuminating dense, thick, rubber-like, and toxic sealant materials within a storage container and enabling an operator to selectively direct a high-power pulsed laser beam of uniform density with a variable pulse rate of ten to one thousand hertz per second to explosively detach and vaporize the illuminated sealant materials and continuously image collection and removal of the sealant materials in an ambient oxygen atmosphere within the storage container,
high volume gas and particulate filtering apparatus having an evacuation hose sized for insertion in combination with the articulated wand into the access port of the fuel cell storage container to evacuate the vaporized sealant materials from within the storage container, and
monitoring apparatus coupled through the articulated wand to the delivery head for continuously imaging the collection and removal of the sealant materials and enabling the operator to guide the delivery head to sealant materials within the storage container and monitor and record each operation of removing sealant materials.
